(19) United States
(12) Patent Application Publication
(10) Pub. No.: US 2008/0221980 A1
(43) Pub. Date: Sep. 11, 2008

(54) SYSTEM AND METHOD FOR THE ELECTRONIC GENERATION AND DELIVERY OF COUPONS

(75) Inventors: Daniel Greeson, Atlanta, GA (US); Matthew McFee, Waxhaw, GA (US); Clyde Morgan, Roswell, GA (US)

Correspondence Address: CANTOR COLBURN, LLP, 20 Church Street, 22nd Floor, Hartford, CT, 06103, US

(73) Assignee: ORIGIN DATA, INC., Atlanta, GA (US)

(21) Appl. No.: 11/684,458

(22) Filed: Mar. 9, 2007

(51) Int. Cl. G06Q 30/00

(52) U.S. Cl. 705/14

(57) ABSTRACT

The present invention relates to electronic coupon generation and delivery. Within the invention UPCs are obtained for predetermined products in addition to registration information from a potential customer, the registration information being received in response to a request for registration information that is associated with the predetermined product. A request is transmitted from the potential customer to print out a hard copy of a coupon that is associated with the predetermined product, and thereafter an identifier is created for the potential customer. The potential customer's identifier is associated with the UPC of the predetermined product. In the event that a request to print out a coupon is fulfilled, the coupon image is transmitted to the potential customer's computing system, wherein the coupon image is masked from display to the potential customer, and a hard copy of the coupon image is printed out at the potential customer's printing device.

### BACKGROUND OF THE INVENTION

1. Field of the Invention

This invention relates to the electronic generation and delivery of coupons, and particularly to the generation and electronic delivery of coupons directly to a consumer's computing system's printer device, wherein a visual image of the generated coupon is not displayed to the consumer.

2. Description of the Background

Conventionally, marketers have provided coupons for products or services to potential customers via newspaper, magazine, and direct consumer mailing media. However, the cost benefits of these marketing methodologies may not be fully realized by a business because a potential customer may neither receive the coupon nor redeem the coupon, thus resulting in lost marketing costs for the business. A contemporary coupon marketing delivery approach allows for a potential consumer to access websites that are maintained by respective businesses and at the website print out coupons that are displayed to the potential consumer via a display device. This coupon delivery approach also presents marketing difficulties, in that a business can potentially exert no control over the number of times that a coupon is accessed and printed out by an individual consumer, thereby keeping an individual from abusing the discounted access to a particular product or service.

Therefore, there exists a need for a system and methodology for the electronic generation and delivery of coupons, wherein the coupon delivery system is configured to monitor a consumer's access to a particular coupon and the delivery of the designated coupon to a consumer.

### SUMMARY OF THE INVENTION

The shortcomings of the prior art are overcome and additional advantages are provided through the provision of a method for the electronic generation and delivery of coupons, the method comprising the obtaining of a UPC for a predetermined product, and receiving registration information from a remotely located computing system user, wherein the registration information is received in response to a request for registration information that is associated with the predetermined product. The method further comprises receiving a request from the remote computing system user to print out a hard copy of a coupon that is associated with the predetermined product, creating an identifier for the computing system user, associating the computing system user identifier with the UPC of the predetermined product. Yet further, the method comprises generating a coupon image, transmitting the coupon image to the remote computing system, wherein the coupon image is masked from display to the remote computing system user, and printing out a hard copy of the coupon image at a printing device comprised within the remote computing system.

Further comprised within aspects of the present invention is a system for the electronic generation and delivery of product specific coupons, the system comprising a remote computing system, the remote computing system comprising a display device and a printing device, at least one remote server computer, wherein the remote server computer is in communication with the remote computing system via a network, and the remote server computer being configured to transmit requested product specific web pages for display at the display device of the remote computing system. The system further comprises at least one local server computer, wherein the local server computer is in communication with the remote computing system and the remote server computer via the network, the local server computer being configured to receive coupon image data printout requests from, and transmit the requested coupon image data to the remote computing system, and the transmitted requested coupon data being masked from the display device of the remote computing system. Further comprised is at least one database storage device, the database storage device being in electrical communication with at least one local server computer.

Computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a coupon generation and delivery system as described within aspects of the present invention.

FIG. 2 illustrates one example of a coupon printing flow diagram that can be implemented within embodiments of the present invention.

FIG. 3 illustrates one example of a flow diagram detailing aspects of a coupon generation and delivery methodology that can be implemented within embodiments of the present invention.

The detailed description explains the preferred embodiments of the invention, together with advantages and features, by way of example with reference to the drawings.

### DETAILED DESCRIPTION

One or more exemplary embodiments of the invention are described below in detail. The disclosed embodiments are intended to be illustrative only since numerous modifications and variations therein will be apparent to those of ordinary skill in the art. The terms “a” and “an” herein do not denote a limitation of quantity, but rather denote the presence of at least one of the referenced item.

Aspects of the present invention relate to systems and methodologies for the creation and delivery of product or service specific coupons to a potential consumer upon the reception of a coupon request from the consumer. More specifically, when a potential consumer accesses the website of a particular advertised service or product via a networked computer system, the potential consumer will be presented with an opportunity to print out at her printer a coupon, the coupon offering a discount off the price of the advertised service or product.

For example, a potential consumer arrives at a webpage that is advertising a particular product. Within the webpage, a hyperlinked coupon offer associated with the advertised product is displayed to the potential consumer. The potential customer clicks on the coupon hyperlink and is thereafter taken to a consumer information registration webpage. In order to obtain the offered coupon the potential consumer must “opt-in” for the offered coupon by completing a consumer information form and submitting the requested consumer information to the coupon service provider. Once the potential consumer has completed and submitted the consumer information the consumer information is used to initiate a coupon generation and distribution process that results in an electronic image of the requested coupon being transmitted directly to a printing device that is comprised within the networked computing system of the potential consumer.

More specifically, within aspects of the present invention the coupon print out process does not require the implementation of a dedicated software application download (e.g., an Active X control) to facilitate the printing out of a requested coupon. On the contrary, within aspects of the present invention the information flow from the potential consumer registration process to the coupon print out operation requires only that the potential consumer accept a displayed notice for an applet at their web browser. Once accepted by the potential consumer the applet is written to the potential consumer's computing system, without the requirement of additional active involvement by the potential consumer. Thus, within aspects of the present invention there is no need to display a print dialogue screen to the potential customer in order to initiate a coupon print out operation.

This aspect of the present invention is accomplished by the applet's utilization of the computing system's default printer settings to perform a print out operation, therefore functionaly negating the potential consumer's ability to reconfigure a print out operation (i.e., perform such actions as changing the number of copies to be printed out, selecting a printer, etc.). Thus, within the present invention, the active downloading or running of an application is not needed to accomplish a coupon print out operation; as such, the only necessary action to be performed within the present invention is that of the potential consumer acknowledging that an applet will initiate the coupon print out operation.

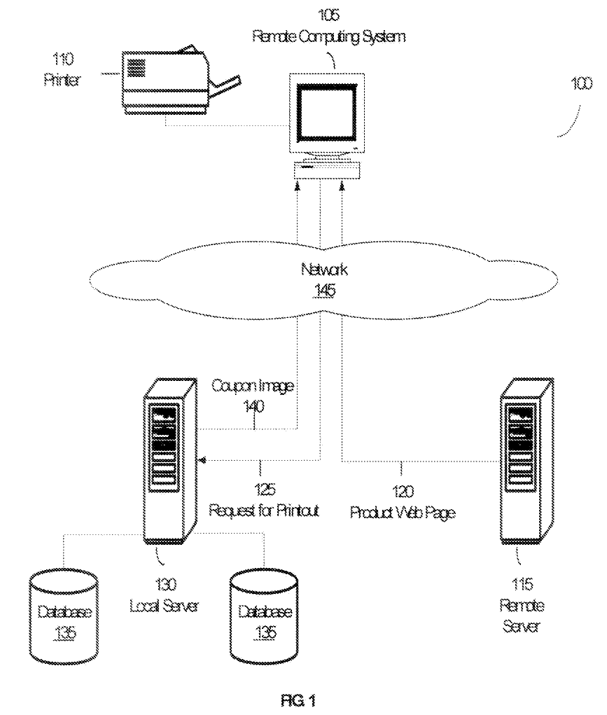

Turning now to the drawings in greater detail, it will be seen that in FIG. 1 there is illustrated a system 100 for the generation and delivery of electronic product specific coupons. Within aspects of the present invention the system 100 comprises a remote computing system 105, the remote computing system 105 comprising a display device and a printing device 110, and at least one remote server computer 115, wherein the remote server computer 115 is in communication with the remote computing system 105 via a network 145. The remote server computer 115 is configured to host the product specific web pages 120 that are accessed for display at the display device of the remote computing system 105. The system 100 further comprises at least one local server computer 130 and at least one database storage device 135 that serves as a dedicated storage device for the local server computer 130.

Further, the local server computer 130 is in communication with the remote computing system 105 and the remote server computer 115 via the network 145. The local server computer 130 is configured to receive coupon image data printout requests 125 from the remote computing system 105, and transmit requested coupon image data 140 to the remote computing system 105. In particular, within aspects of embodiments of the present invention the transmitted requested coupon image data 140 is purposely masked from being displayed at the display device of the remote computing system 105.

As mentioned above, the remote server computer 115 handles a request for a product specific webpage 120. Once presented with the requested webpage the potential customer clicks on a displayed coupon hyperlink and is thereafter taken to a consumer information registration webpage. At the consumer information registration webpage, the potential consumer completes and submits her answers to a predetermined set of requested consumer information questions to the coupon service provider, the consumer registration information concurrently being transmitted to the local server computer 130.

At the local server computer 130 the consumer registration information is used to create a unique consumer ID code (e.g., the email address of the potential consumer could be used to generate an ID by utilizing conventional encryption methods). The unique consumer ID code is thereafter associated within the potential consumer's registration information, wherein this associated information is used to create a profile for the potential consumer; the unique ID code, consumer registration information, and consumer profile being stored at a database storage device 135.

Within aspects of the present invention, a UPC for the product is entered into a coupon table at the database storage device 135 for each featured product that is associated with a coupon. Additional information relating to a particular product is also stored at a database storage device 135 (e.g., the expiration date of the coupon offer and any additional variable information that is needed to complete the printing out of the coupon offer). Each unique consumer ID code that is generated will be associated with the UPC of the product and stored at a database storage device 135.

In response to the submission of the requested consumer information, a coupon printout request webpage is displayed to the potential consumer at the remote computing system 105. The coupon printout request page presents the potential consumer with the option to print out a hard copy image of the coupon that is being offered. In the event that the potential consumer transmits a request 125 for a printout of the coupon, the coupon image is transmitted directly to the printer 110 of the remote computing system 105 without being displayed to the requesting potential consumer.

Within further aspects of the present invention, each unique consumer ID code is further associated with a coupon printout table, wherein the coupon printout table stores data relating to an allowable coupon volume printout capacity and a printed coupon volume variable. In the event that a request 125 to print out a coupon is less than the predetermined printout amount, then the coupon image data 140 is transmitted to the remote printing device 110 and a hard copy of the coupon image is printed out at the remote printing device 105. Conversely, in the event that a request 125 to print out a coupon is greater than, or equal to, the predetermined printout amount, then a notification is transmitted to the remote computing system 105 display device informing the potential consumer that they have reached the maximum allowable amount of downloaded coupon printouts.

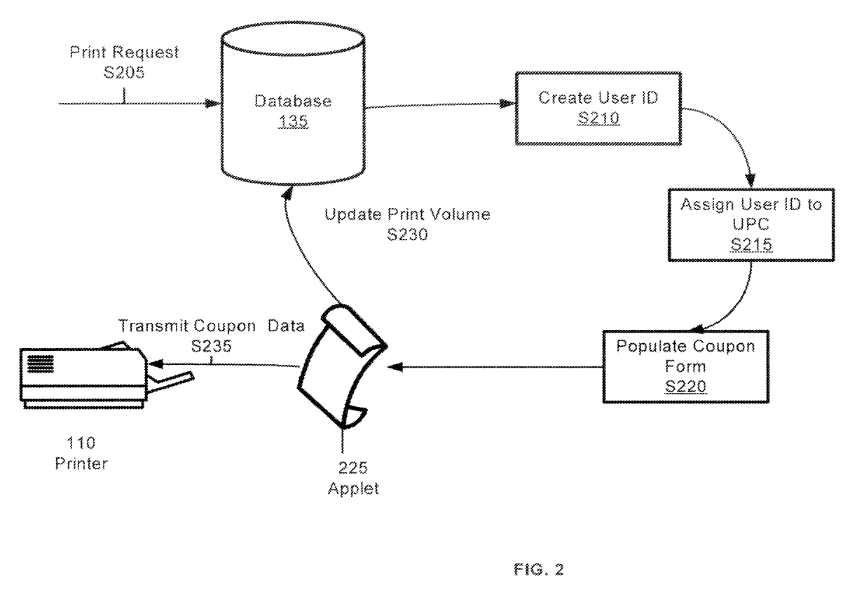

FIG. 2 illustrates a technology flow for the creation and delivery of a requested product specified coupon. At step 205 a coupon printout request is received at a database storage device 135. At step 210 a unique consumer ID code is created, and at step 215, the unique consumer ID code is associated with the UPC of the requested product. This ID and UPC associative step additionally facilitates the implementation of coupon print monitoring operations within aspects of the present invention. At step 220 the coupon that is the subject of the coupon request is created. Requested coupons are created by populating a predetermined coupon form with product specific information that is determined to be necessary (e.g., product brands, the UPC of the product, point-of-sale necessitated information, coupon expiration date etc . . . ), and thereafter configuring the coupon into a conventional image format.

A fundamental aspect of the present invention is that the created coupon image is never presented for display to the requesting potential consumer. The reason for this aspect is that by not presenting the image to the potential consumer, the possibility that the coupon image will be captured and possibly altered is minimized. Thus a created coupon image is directly transmitted to the printer 110 of a remote computing system 130 (step 235). As mentioned above, within aspects of the present invention this functionality is accomplished by the use of an applet 225. As written, the applet 225 is responsible for transmitting a requested coupon image directly to the printer 110 of the remote computer system 130 and updating the coupon printout table.

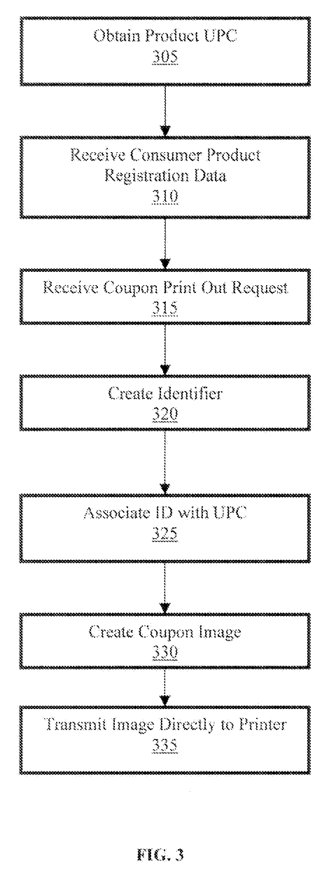

FIG. 3 shows a flow diagram detailing aspects of a method for the electronic generation and delivery of a coupon. At step 305, UPCs are obtained for predetermined products. At step 310, registration information is received from a remotely located computing system user, wherein the registration information has been received in response to a request for registration information that is associated with a predetermined product. At step 315, a request is received from a remote computing system 105 user to print out a hard copy of a coupon that is associated with the predetermined product.

At step 320 an identifier is created for the remove computing system 105 user, and thereafter at step 325, the remote computing system 105 user identifier is associated with the UPC of the predetermined product. Next, at step 330 a coupon image is generated, and at step 335, the coupon image is directly transmitted to the printer 110 of the remote computing system 105, wherein the coupon image is masked from display to the remote computing system 105 user. Lastly, a hard copy of the coupon image is printed out at the printing device 110.

The capabilities of the present invention can be implemented in software firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for the electronic generation and delivery of a coupon, the method comprising:
obtaining a UPC for a predetermined product;
receiving registration information from a remotely located computing system user, wherein the registration information is received in response to a request for registration information that is associated with the predetermined product;
receiving a request from the remote computing system user to print out a hard copy of a coupon that is associated with the predetermined product;
creating an identifier for the computing system user;
associating the computing system user identifier with the UPC of the predetermined product;
generating a computer image,
transmitting the coupon image to the remote computing system, wherein the coupon image is masked from display to the remote computing system user; and
printing out a hard copy of the coupon image at a printing device comprised within the remote computing system.

2. The method of claim 1, further comprising the displaying of a print job status indication message at a display device comprised within the remote computing system display device.

3. The method of claim 2, wherein the coupon image is created by populating a coupon form with the computing system user identifier, a barcode representation of the UPC of the predetermined product, and a plurality of predetermined data elements.

4. The method of claim 3, wherein the volume of printouts of coupons for a system user in regard to the predetermined product is set at a predetermined amount.

5. The method of claim 4, where in the event that a request to print out a coupon is less than the predetermined printout amount, then the coupon image is transmitted to the remote printing device.

6. The method of claim 5, where in the event that a request to print out a coupon is greater than or equal to the predetermined printout amount, then a notification is displayed to the remote computing system user informing the system user that they have reached a maximum allowable amount of printouts.

7. The method of claim 6, wherein the data elements can comprise a product brand image, the expiration date of a product coupon offer, and a retailer notification message.

8. A system for the electronic generation and delivery of product specific coupons, the system comprising:
a remote computing system, the remote computing system comprising a display device and a printing device;
at least one remote server computer, wherein the remote server computer is in communication with the remote computing system via a network, the remote server computer being configured to transmit requested product specific web pages for display at the display device of the remote computing system;
at least one local server computer, wherein the local server computer is in communication with the remote computing system and the remote server computer via the network, the local server computer being configured to receive coupon image data print out requests from, and transmit the requested coupon image data to the remote computing system, the transmitted requested coupon data being masked from the display device of the remote computing system; and
at least one database storage device, the database storage device being in electrical communication with the at least one local server computer.

9. The system of claim 8, wherein the UPCs of a plurality of predetermined products are stored at the database storage device.

10. The system of claim 9, wherein a remote computing system user enters and transmits coupon registration data in response to a request for registration information that is featured within a product specific web page that is associated with a predetermined product to the remote computer server.

11. The system of claim 10, wherein the registration information is transmitted from the remote server computer to the local server computer thereinafter the registration information is transmitted to the database storage device for storage.

12. The system of claim 11, wherein an identifier for a remote computing system user is created in response to the local server computer receiving a request from the remote computing system user to print out a hard copy of a coupon that is associated with a predetermined product, the identifier thereafter being stored at the database storage device.

13. The system of claim 12, wherein the identifier for the remote computing system user is associated with the UPC of the predetermined product within the database storage device.

14. The system of claim 13, wherein the volume of printouts of coupons for a remote computing system user in regard to the predetermined product is set at a predetermined amount.

15. The system of claim 14, where in the event that a request to print out a coupon is less than the predetermined printout amount, then the coupon image data is transmitted to the remote printing device and a hard copy of the coupon image is printed out at the remote printing device.

16. The system of claim 15, where in the event that a request to print out a coupon is greater than or equal to the predetermined printout amount, then the a notification is transmitted to the remote computing system display device informing the system user that they have reached a maximum allowable amount of printouts.

17. A computer program product that includes a computer readable medium useable by a processor, the medium having stored thereon a sequence of instructions which, when executed by the processor, causes the processor to generate and deliver a coupon to a remote computing system, wherein the coupon is generated and delivered by:
receiving a UPC for a predetermined product;
receiving registration information from a remotely located computing system user, wherein the registration information is received in response to a request for registration information that is associated with the predetermined product;
receiving a request from the remote computing system user to print out a hard copy of a coupon that is associated with the predetermined product;
creating an identifier for the computing system user;
associating the computing system user identifier with the UPC of the predetermined product;
generating a computer image,
transmitting the coupon image to the remote computing system, wherein the coupon image is masked from display to the remote computing system user.

18. The computer program product of claim 17, further comprising transmitting a print job status indication message at a display device comprised within the remote computing system display device.

19. The computer program product of claim 18, wherein the coupon image is created by populating a coupon form with the computing system user identifier, a barcode representation of the UPC of the predetermined product, and a plurality of predetermined data elements.

20. The computer program product of claim 18, wherein the volume of printouts of coupons for a system user in regard to the predetermined product is set at a predetermined amount.
